(19) United States
(12) Patent Application Publication
(10) Pub. No.: US 2023/0141976 A1
(43) Pub. Date: May 11, 2023

(54) A SYSTEM AND METHOD TO DETECT COUNTERFEIT PRODUCTS

(71) Applicant: SEPIO SOLUTIONS PRIVATE LIMITED, Maharashtra (IN)

(72) Inventors: Murad Nathani, Maharashtra (IN); Darshan Dhruman Gandhi, Maharashtra (IN); Paul Abner Noronha, Maharashtra (IN); Dattaprasad Narayan Kamat, Maharashtra (IN)

(21) Appl. No.: 17/916,722

(22) PCT Filed: Jun. 1, 2021
(86) PCT No.: PCT/IB2021/054796

§ 371 Date: Oct. 3, 2022

(30) Foreign Application Priority Data
Jun. 15, 2020 (IN) 202021025053

(51) Int. Cl. G06Q 30/018; G06K 7/10

(52) U.S. Cl. CPC G06Q 30/0185; G06K 7/10; G06K 2007/10504

(57) ABSTRACT

The present disclosure relates to the field of product authentication and counterfeit detection and discloses a system and method to detect counterfeit products. The system (100) comprises a first scanner (102), an application (132) loaded in a user device (114) and a server (110). The first scanner (102) scans images of visual codes printed on products manufactured and packaged on a production line and assigns product details to the visual codes. The application (132) facilitates a user to scan said visual codes and redirects the user to an encoded URL to view the product details. The application (132) captures and transmits a browser ID and location data to the server (110) and allows users to provide inputs to a pre-determined set of questions. The server (110) derives scanning indices from the received browser ID and location data and identifies counterfeit products based on said scanning indices and inputs.

### FIELD

The present disclosure relates to a system and method to detect counterfeit products.

### BACKGROUND

The background information herein below relates to the present disclosure but is not necessarily prior art.

In today’s time, in order to verify whether a product is fake or genuine, many techniques are available. The most common techniques rely on the use of Radio Frequency tags and QR codes at manufacturing or shipping stages. Even though the existing products are provided with anti-counterfeit tags, it is not uncommon for counterfeit goods to enter into high-end retail stores.

Further, repeated scanning of QR codes by the same device for the same unique ID does not help in concluding if a product is a genuine or a fake product. The product’s batch number also does not help in concluding if it’s a genuine or a counterfeit product. Thus, the existing anti-counterfeiting ways are not sufficient in preventing counterfeit products from entering the market.

In addition to this, in the existing anti-counterfeiting measures, there is no consideration of the location and the unique ID of the device from which a product’s QR code is scanned. This makes it easy for the counterfeiters to circulate fake products in the market and the consumer is easily fooled in buying these fake products. Hence, company faces the risk of losing customers and its reputation.

Therefore, there is a need for a system and method that takes into consideration additional scanning information such as location of scan and frequency of scan, to detect counterfeit products and alleviates the aforementioned drawbacks.

### OBJECTS

Some of the objects of the present disclosure, which at least one embodiment herein satisfies, are as follows:

It is an object of the present disclosure to ameliorate one or more problems of the prior art or to at least provide a useful alternative.

An object of the present disclosure is to provide a system to detect counterfeit products.

Another object of the present disclosure is to provide a system that considers information related to the scanning of visual codes, such as scanning location, frequency of scanning, and ID of device from which the code is scanned, to detect counterfeit products.

Still another object of the present disclosure is to provide a system that effectively detects counterfeit products and is easy to implement.

Yet another object of the present disclosure is to provide a self-correcting system for detecting counterfeit products that improves its accuracy by learning from feedback data.

Other objects and advantages of the present disclosure will be more apparent from the following description when read in conjunction with the accompanying figures, which are not intended to limit the scope of the present disclosure.

### SUMMARY

The present disclosure envisages a system to detect counterfeit products.

The system comprises a first scanner, an application loaded in a user device and a server.

The first scanner is installed on a production line and is configured to scan images of visual codes printed on products manufactured and packaged on the production line, and is further configured to assign product details to the visual code of each of the products. The product details include, but are not limited to, batch number, manufacturing date, and expiry date.

In an embodiment, the first scanner includes a video capturing device and an assignment module. The video capturing device is configured to scan the images of the visual codes printed on the products. The assignment module is configured to cooperate with the server to assign the product details to the visual codes.

The application loaded in a user device is configured to facilitate a user associated with the user device to scan the visual code, and is further configured to re-direct the user to an encoded URL to view the product details. The application is configured to capture and transmit a browser ID and location data of the user device. The application is further configured to facilitate the user to provide at least one input corresponding to a set of pre-defined questions to ascertain whether or not the product is authentic.

In an embodiment, the application includes a second scanner and a graphical interface. The second scanner is configured to scan the visual code on the product and capture device ID and the location data of the user device, and is further configured to re-direct the user to the encoded URL that opens in a browser where the user can view the product details. The second scanner is further configured to capture and transmit the browser ID and the location data to the server. The graphical interface is configured to facilitate the user to provide the inputs corresponding to the set of pre-defined questions to ascertain whether or not the product is authentic.

The server is configured to store the product details and cooperate with the first scanner to facilitate assignment of the product details to the visual codes. The server is configured to cooperate with the user device to receive and store the browser ID and location data associated with the scanning of the visual codes on the products and the user inputs. The server is further configured to derive a plurality of scanning indices associated with each of the products based on the received browser ID and location data and identify whether or not the products are counterfeit, based on the scanning indices and the user inputs.

In an embodiment, the server comprises a computation unit, a repository and a verification module.

The computation unit is configured to receive browser IDs and location data associated with user devices scanning the visual codes of each of the products, and is further configured to derive the scanning indices based on the received browser IDs and location data.

The repository is configured to cooperate with the computation unit and store:
a first lookup table having a list of product IDs associated with the products, browser ID and location data associated with scanning of said products, and the scanning indices associated with each of the product IDs and pre-determined thresholds corresponding to each of the scanning indices; and
a second lookup table having a list of the product IDs and the corresponding product details.

The verification module is configured to cooperate with the repository and the user device to identify whether or not the product is counterfeit, based on the scanning indices and the inputs.

In an embodiment, the scanning indices include:
number of the user devices that have scanned the product’s code (N_{d});
count of number of location changes (N_{L});
location number or identification of the location (L_{N});
frequency of scans (F); and
time period between successive scans (T).

Accordingly, the pre-determined thresholds include:
maximum number of the user devices to scan the product on a retail shelf before buying the product and the code is killed/not available to scan anymore (X);
maximum number of the location changes (N_{L}) allowed before the product is declared suspicious (Y);
maximum number of the location changes (N_{L}) allowed before the product is declared as counterfeit (Z);
maximum scanning frequency (F) allowed before the product is declared as suspicious or counterfeit (F_{M}); and
maximum time period between successive scans (T) allowed before the product is declared as suspicious or counterfeit (T_{M}).

The verification module includes a first comparator, a second comparator, a third comparator, a query generator and an analyser.

The first comparator is configured to compare the Nd with the X, and is further configured to generate a first fake signal if the Nd is less than or equal to the X, or else generate a positive signal.

The second comparator is configured to cooperate with the first comparator to compare the N_{L} with the Y upon receiving the positive signal. If N_{L} is found to be less than Y, the second comparator is further configured to compare current location of the user device with its previous location stored in the repository to:
generate a first genuine signal if the current location is same as the previous location; or
generate a second genuine signal and update the previous location to current location in the repository, if the current location is same as the previous location.

The third comparator (126) is configured to compare N_{L} with Z, if N_{L} is found to be less than Y and determine if N_{L} is less than or equal to Z, the third comparator is further configured to:
generate a suspicion signal if N_{L} is found to be greater than Y but less than and equal to Z; or
generate a second fake signal if N_{L} is found to be greater than Z.

The query generator is configured to receive the suspicion signal, and is further configured to generate and transmit the set of pre-defined questions to the user device to receive the inputs related to the product purchase.

The analyser is configured to analyse the inputs, and generate a third genuine signal if the product is found to be genuine based on the analysis, else generate a third fake signal.

The notification generator is configured to cooperate with the first comparator, the second comparator, the third comparator, and the analyzer to receive one of the first, second, and third fake signals and the first, second, and third genuine signals, the notification generator is further configured to generate and transmit:
a first message that the purchased product is genuine upon receiving one of the first, second and third genuine signals; and
a second message that the purchased product is counterfeit/fake upon receiving one of the first, second and third fake signals.

The first and second messages are received and displayed on the user device.

The server includes a learning module configured to periodically determine the values of the pre-determined thresholds to accurately represent the product’s behavior by implementing machine learning techniques and update the values of the pre-determined thresholds in the repository.

The present disclosure envisages a method for detecting counterfeit products. The method comprises the following steps:
scanning, by a first scanner, images of visual codes printed on products manufactured and packaged on the production line;
assigning, by the first scanner, product details to the visual code of each of the products;
facilitating, by an application loaded in a user device, a user associated with the user device to scan the visual code;
re-directing, by the application, the user to an encoded URL to view the product details;
capturing and transmitting, by the application, a browser ID and location data of the user device;
storing, by a server, the product details;
receiving and storing, by the server, the browser ID and location data associated with user devices scanning the products and the user inputs;
deriving, by the server, a scanning indices associated with each of the products based on the received browser ID and location data;
facilitating, by the application, the user to provide at least one input corresponding to a set of pre-defined questions to ascertain whether or not the product is authentic; and
identifying, by the server, whether or not the products are counterfeit, based on the scanning indices and the user inputs.

### BRIEF DESCRIPTION OF THE ACCOMPANYING DRAWING

A system and method to detect counterfeit products of the present disclosure will now be described with the help of the accompanying drawing, in which:

FIG. 1 illustrates a block diagram of a system to detect counterfeit products;

FIGS. 2a and 2b illustrate a flow diagram of a method to detect counterfeit products; and

FIGS. 3a and 3b illustrate a flow chart depicting the logic to detect counterfeit products.

### LIST OF REFERENCE NUMERALS

100 - System
102 - first scanner
104 - video capturing device
106 - assignment module
108 - repository
110 - server
114 - user device
116 - second scanner
118 - graphical interface
120 - verification module
122 - first comparator
124 - second comparator
126 - third comparator
128 - query generator
130 - analyser
132 - application
134- computation unit
136- notification generator
138- learning module

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details, are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “including,” and “having,” are open ended transitional phrases and therefore specify the presence of stated features, integers, steps, operations, elements and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

The present disclosure relates to a system and method to detect counterfeit products.

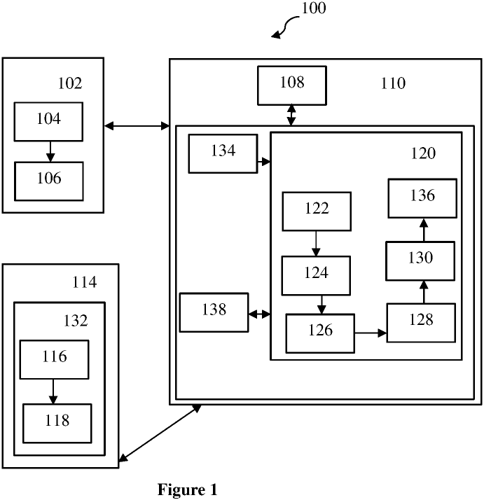

A preferred embodiment of a system (100) to detect counterfeit products, of the present disclosure is now being described in detail with reference to the FIG. 1 through FIG. 3b.

A company generates a series of visual codes for its products which are manufactured for sale. There can be many ways to print the generated visual codes on the outer surface of a product or its outer packaging.

The company can directly print the visual code using a digital printer installed on the production line after the product’s filling and packaging is done, or the company or its vendor can first print the visual code on the outer package (sleeves, carton, labels, etc.) using a digital printer. Either the company gives the series of unique IDs to its vendor, or the vendor can generate the IDs by any third-party system by themselves and then print them on the outer packaging by providing the outer packaging with a pre-printed visual code before the production, or the packaging of the product starts.

Referring to FIG. 1, the system (100) to detect counterfeit of the present disclosure comprises a first scanner (102), an application (132) loaded in a user device (114) and a server (110). The first scanner (102) is installed on a production line and is configured to scan images of visual codes printed on products manufactured and packaged on the production line, and is further configured to assign product details to the visual code of each of the products. The product details may include, but are not limited to, batch number, manufacturing date, and expiry date.

In an embodiment, the first scanner (102) includes a video capturing device (104) and an assignment module (106).

The video capturing device (104) is configured to scan the images of the visual codes printed on the products. The assignment module (106) is configured to cooperate with the server (110) to assign the product details to the visual codes.

The application (132) loaded in a user device (114) is configured to facilitate a user associated with the user device (114) to scan the visual code, and is further configured to re-direct the user to an encoded URL to view the product details. The application (132) is configured to capture and transmit a browser ID and location data of the user device (114). The user device (114) is further configured to facilitate the user to provide at least one input corresponding to a set of pre-defined questions to ascertain whether or not the product is authentic.

In an embodiment, the application (132) includes a second scanner (116) and a graphical interface (118).

The second scanner (116) is configured to scan the visual code on the product and capture device ID and the location data of the user device (114), and is further configured to re-direct the user to the encoded URL that opens in a browser where the user can view the product details. The second scanner (116) is further configured to capture and transmit the browser ID and the location data to the server (110). The graphical interface (118) is configured to facilitate the user to provide the inputs corresponding to the set of pre-defined questions to ascertain whether or not the product is authentic.

In an embodiment, the frequency of scan and the time period between the scans are significant in order to detect counterfeit products.

In an embodiment, the user device (114) may be selected from the group consisting of, but not limited to, a smart watch, a smartphone, a tracker, a laptop, a desktop, and a palmtop.

In another embodiment, if the visual code is scanned using the application (132), the system (100) captures other details of the user device (114) like device ID. In an embodiment, the visual code is scanned using any visual code scanner application available on any application on the user device (114). The visual code can also be scanned by an image capturing device.

The server (110) is configured to store the product details and cooperate with the first scanner (102) to facilitate assignment of the product details to the visual codes and activation of the visual codes. The server (110) is configured to cooperate with the user device (114) to receive and store the browser ID and location data associated with the scanning of the products and the user inputs. The server (110) is further configured to derive a scanning indices associated with each of the products based on the received browser ID and location data and identify whether or not the products are counterfeit, based on the scanning indices and the user inputs.

In an embodiment, the server (110) comprises a computation unit (134), a repository (108) and a verification module (120).

The computation unit (134) is configured to receive browser IDs and location data associated with user devices (114) scanning the visual codes of each of the products, and is further configured to derive the scanning indices based on the received browser IDs and location data.

The repository (108) is configured to cooperate with the computation unit (134) and store:
a first lookup table having a list of product IDs associated with the products, browser ID and location data associated with scanning of said products, and the scanning indices associated with each of the product IDs and pre-determined thresholds corresponding to each of the scanning indices; and
a second lookup table having a list of the product IDs and the corresponding product details.

In an embodiment, the scanned visual codes are activated by the server (110)/auto-activated.

Once the visual code is activated and the products are in the market for sale, a customer can scan the unique ID/ visual code using a user device (114) (using any generic visual code scanner) and view the information that has been paired with that ID.

The verification module (120) is configured to cooperate with the repository (108) and the user device (114) to identify whether or not the product is counterfeit, based on the scanning indices and the inputs.

In an embodiment, the scanning indices include:
number of the user devices that have scanned the product’s code (N_{d});
count of number of location changes (N_{L});
location number or identification of the location (L_{N});
frequency of scans (F); and
time period between successive scans (T).

Accordingly, the pre-determined thresholds include:
maximum number of the user devices to scan the product on a retail shelf before buying the product and the code is killed/not available to scan anymore (X);
maximum number of the location changes (N_{L}) allowed before the product is declared suspicious (Y);
maximum number of the location changes (N_{L}) allowed before the product is declared as counterfeit (Z);
maximum scanning frequency (F) allowed before the product is declared as suspicious or counterfeit (F_{M}); and
maximum time period between successive scans (T) allowed before the product is declared as suspicious or counterfeit (T_{M}).

In an embodiment, any one or a combination of all the indices may be employed to check authenticity. In another embodiment, the order in which the parameters are checked can be changed.

In an embodiment, the verification module (120) includes a first comparator (122), a second comparator (124), a third comparator (126), a query generator (128), an analyser (130) and a notification generator (136).

The first comparator (122) is configured to compare the Nd with the X, and is further configured to generate a first fake signal if the Nd is less than or equal to the X, or else generate a positive signal.

The second comparator (124) is configured to cooperate with the first comparator (122) to compare the N_{L} with the Y upon receiving the positive signal. if N_{L} is found to be less than Y, the second comparator (124) is further configured to compare current location of the user device (114) with its previous location stored in the repository (108) to:
generate a first genuine signal if the current location is same as the previous location; or
generate a second genuine signal and update the previous location to current location in the repository (108), if the current location is same as the previous location.

The third comparator (126) is configured to compare N_{L} with Z, if N_{L} is found to be less than Y and determine if N_{L} is less than or equal to Z, the third comparator further configured to:
generate a suspicion signal if N_{L} is found to be greater than Y but less than and equal to Z; or
generate a second fake signal if N_{L} is found to be greater than Z.

The query generator (128) is configured to receive the suspicion signal, and is further configured to generate and transmit the set of pre-defined questions to the user device (114) to receive the inputs related to the product purchase.

The analyser (130) is configured to analyse the inputs, and generate a third genuine signal if the product is found to be genuine based on the analysis, else generate a third fake signal.

The notification generator (136) is configured to cooperate with the first comparator (122), the second comparator (124), the third comparator (126), and the analyzer (128) to receive one of the first, second, and third fake signals and the first, second, and third genuine signals. The notification generator (136) is further configured to generate and transmit:
a first message that the purchased product is genuine upon receiving one of the first, second and third genuine signals; and
a second message that the purchased product is counterfeit/fake upon receiving one of the first, second and third fake signals.

The first and second messages are received and displayed on the user device (114).

The query generator (128) may, for example, generate questions to ascertain whether or not the user or someone known to the user has already made the purchase of the product. If the input provided by the user in response to this question is yes, the result is that the product is genuine. The next user scanning the same product ID from a different user device (114) will have a message displayed that the product has been already marked as sold and is not for sale or any other message which may be stored in the repository (108).

If the user’s answer is no, the result is that the product is counterfeit. The user may be provided additional details like shop name/picture of the product or any other message/questionnaire which may be stored in the repository (108). All subsequent scans of this visual code by any next user will be declared as a counterfeit.

In an embodiment, if the user clears the cache of the browser or deletes the user device’s (114) data, the system (100) may consider the user device (114) as a new user/device/browser.

The server (110) includes a learning module (138) configured to periodically determine the values of the pre-determined thresholds to accurately represent the product’s behavior by implementing machine learning techniques and update the values of the pre-determined thresholds in the repository (108).

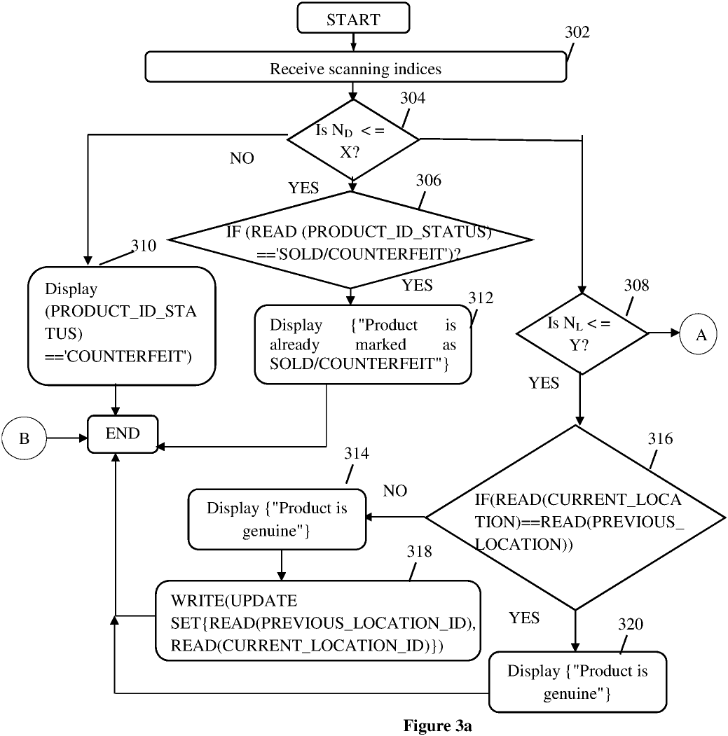

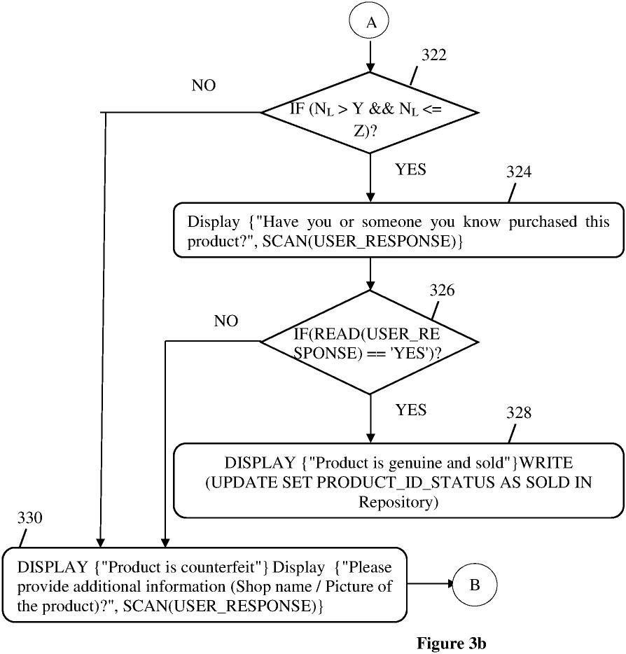

Referring to FIGS. 3a and 3b, the pseudo code depicting the functionality of the system (100) is as follows:

START
SELECT {ALL * from Repository}
RECEIVE SCANNING INDICES (302)
VAR N_{D} = N_{D} // Number of unique mobile devices that have scanned a
product’s visual code via a mobile app or phone camera. The
device’s browser ID is taken as it’s unique identification
number or if scanned with our proprietary mobile app, the
Mobile Device Identifier itself is treated as its unique identifier.
VAR N_{L} = N_{L} // Count of number of location changes (nos. of times a
products visual code was scanned at a different location).
VAR X = X // Maximum number of unique devices (consumers) we expect
to scan a product on a retail shelf before someone buys the
product and the visual code is killed/not available to scan
anymore.
VAR Y = Y // Maximum number of location changes (N_{L}) allowed before
we declare a product suspicious.
VAR Z = Z // Maximum number of location changes (N_{L})allowed before
we declare a product as counterfeit.
END SELECT
IF(N_{D} < = X) (304)
IF (READ (PRODUCT_ID_STATUS) ==‘SOLD’) (306)
Display {“Product is already marked as SOLD”} (312)
BREAK
ELSE IF ((PRODUCT_ID_STATUS) ==‘COUNTERFEIT’) (306)
DISPLAY {“Product is counterfeit”} (312)
BREAK
ELSE IF(N_{L} < = Y) (308)
IF(READ(CURRENT_LOCATION) ==READ(PREVIOUS_LOCATION))
(316)
Display {“Product is genuine”} (320)
ELSE
Display {“Product is genuine”} (314)
WRITE (UPDATE SET {READ(PREVIOUS_LO̅C̅ATION_ID)
READ(CURRENT_LOCATION_ID)}) (318)
ELSE IF (N_{L} > Y && N_{L} <= Z) (322)
Display {“Have you or someone you know purchased this product?”,
SCAN(USER_RESPONSE)} (324)
IF(READ(USER_RESPONSE) == ‘YES’) (326)
DISPLAY {“Product is genuine and sold”}
WRITE (UPDATE SET PRODUCT_ID_STATUS AS SOLD IN
Repository) (328)
ELSE
DISPLAY {“Product is counterfeit”} (330)
Display {“Please provide additional information (Shop name / Picture
of the product)?”, SCAN(USER_RESPONSE)}
WRITE (UPDATE SET PRODUCT_ID_STATUS AS
COUNTERFEIT IN Repository)
ELSE
DISPLAY {“Product is counterfeit”} (330) Display
{“Please provide additional information (Shop name / Picture of the
product)?”, SCAN(USER_RESPONSE)}
WRITE (UPDATE SET PRODUCT_ID_STATUS AS COUNTERFEIT IN
Repository)
ELSE
Display {“Product is Fake”} (310)
UPDATE (SET X, Y, Z INTO Repository)
END

In an embodiment, X, Y, and Z can be different for different products and can be determined by using neural networks. With sufficient data and on the basis of consumer and auditors’ feedback, the values of X, Y and Z may be updated to accurately represent a products behavior. For example, certain products may be sold exclusively in modern trade and may have a higher value of X, when compared to a prescription drug. Values of X, Y and Z may be manually set initially and will vary by product. In future, Machine Learning may determine the optimal value of X, Y and Z based on data gathered.

The various components/modules of the server (110) and the application (132) are implemented using one or more processor(s).

The processor may be implemented as one or more microprocessors, microcomputers, microcontrollers, digital signal processors, central processing units, state machines, logic circuitries, and/or any device that manipulates signals based on operational instructions. Among other capabilities, the processor may be configured to fetch and execute the set of predetermined rules stored in the memory to control the operation of different modules/units of the system.

In an embodiment, each visual code is a URL with a unique ID extension like https://tru.sale/ab23ys628. The URL extension is the hashed value output of a serial number generated by the system (100).

The system (100) may store the browser ID and keep the count of different browser ID’s that may scan a product/ unique visual code in a retail store, the number of times a visual code is scanned, the location details of every location where the visual code is scanned (location is defined at the latitude/longitude of the user device (114) at the time of scanning), the number of locations where a visual code is scanned from, and the number of times a scan location is changed which is monitored by checking if the current scan location is same as the previous scan location. The radius of the current or previous location can be anywhere between few meters and few hundred kilometers depending on whether the user (previous or current) provides the location access or not (IP address will be taken as location if location access is not given) respectively. Current and previous scan locations will be compared on the basis of the location permission. All subsequent scan locations will be compared against this location on the basis of location accuracy. There will be distance threshold which will be used to determine if the scan is genuine or suspicious. Threshold value will separate as per the comparison of different types of locations. GPS location to GPS location, GPS location to IP-based location and IP-based location to IP-based location.

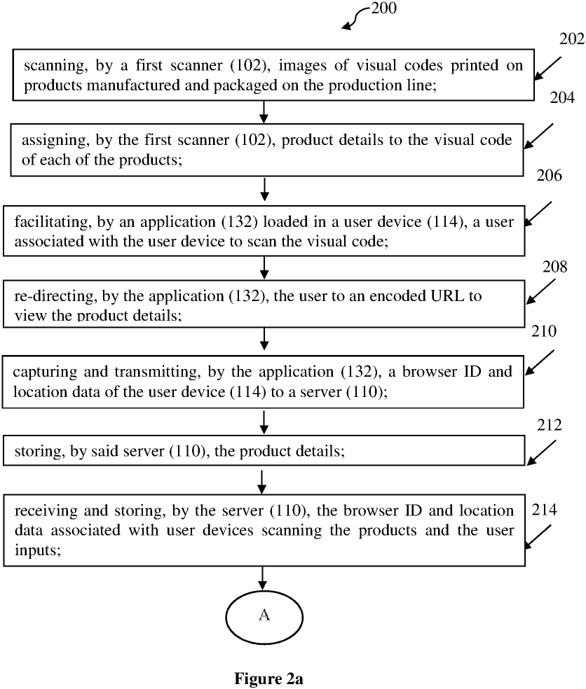

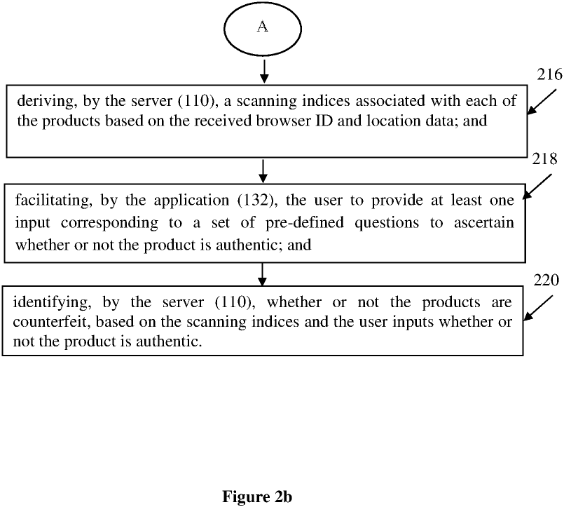

FIGS. 2a and 2b illustrates a method to detect counterfeit products. The steps include:
Step 202: scanning, by a first scanner (102), images of visual codes printed on products manufactured and packaged on the production line;
Step 204: assigning, by the first scanner (102), product details to the visual code of each of the products;
Step 206: facilitating, by an application (132) loaded in a user device (114), a user associated with the user device (114) to scan the visual code;
Step 208: re-directing, by the application (132), the user to an encoded URL to view the product details;
Step 210: capturing and transmitting, by the application (132), a browser ID and location data of the user device (114) to a server (110);
Step 212: storing, by the server (110), the product details;
Step 214: receiving and storing, by the server (110), the browser ID and location data associated with user devices (114) scanning the products and the user inputs;
Step 216: deriving, by the server (110), a scanning indices associated with each of the products based on the received browser ID and location data;
Step 218: facilitating, by the application (132), the user to provide at least one input corresponding to a set of pre-defined questions to ascertain whether or not the product is authentic; and
Step 220: identifying, by the server (110), whether or not the products are counterfeit, based on the scanning indices and the user inputs.

In an exemplary embodiment, the manufactured products in the production line are printed with the unique IDs on the outer packaging or on the product. The first scanner (102) installed on a production line scans images of visual codes printed on products manufactured and packaged on the production line and assigns product details, like batch number, manufacturing date, and expiry date to the visual code of each of the products. The visual codes are then activated by the server (110) or auto-activated.

The application (132) loaded in a user device (114) facilitates a user associated with the user device (114) to scan the printed visual codes, and re-directs the user to an encoded URL to view the product details. The application (132) captures and transmits a browser ID and location data of the user device (114) to a server (110) for verification of the product.

The server (110) stores the product details and facilitate assignment of the product details to the visual codes and activation of the visual codes, receives and stores the browser ID and location data associated with the user devices (114) scanning the products and the user inputs.

The application (132) facilitates the user to provide at least one input corresponding to a set of pre-defined questions to ascertain whether or not the product is authentic.

The server (110) derives scanning indices associated with each of the products based on the received browser ID and location data and identifies whether or not the products are counterfeit, based on the scanning indices and the user inputs.

The messages indicating the authenticity of the product are displayed on the user device (114).

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

### Technical Advancements and Economical Significance

The present disclosure described herein above has several technical advantages including, but not limited to, the realization of, a system and method to detect counterfeit products that:
considers information related to the scanning of visual codes, such as scanning location, frequency of scanning, and ID of device from which the code is scanned, to detect counterfeit products; and
is self-correcting and learns from feedback data; and
effectively detects counterfeit products and is easy to implement.

One of the objects of the Patent Law is to provide protection to new technologies in all fields and domain of technologies. The new technologies shall or may contribute to the country economy growth by way of involvement of new efficient and quality method or product manufacturing in India.

To provide the protection of new technologies by patenting the product or process will contribute significant for innovation development in the country. Further by granting patent the patentee can contribute to manufacturing the new product or new process of manufacturing by himself or by technology collaboration or through the licensing.

The applicant submits that the present disclosure will contribute to country economy, which is one of the purposes to enact the Patents Act, 1970. The product in accordance with present invention will be in great demand in country and worldwide due to novel technical features of a present invention is a technical advancement in detecting the counterfeit products. The technology in accordance with present disclosure will provide

The product will contribute new concept in counterfeit detection wherein the patented system and method will be used. The present disclosure will replace the whole concept of verifying the authenticity of products from decades. The product is developed in the national interest and will contribute to country economy.

The economy significance details requirement may be called during the examination. Only after filing of this Patent application, the applicant can work publicly related to present disclosure product/process/method. The applicant will disclose all the details related to the economic significance contribution after the protection of invention.

The foregoing description of the specific embodiments so fully reveals the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system (100) to detect counterfeit products, said system (100) comprising:
a first scanner (102) installed on a production line, said first scanner (102) configured to scan images of visual codes printed on products manufactured and packaged on said production line, said scanner further configured to assign product details to the visual code of each of said products;
an application (132) loaded in a user device (114), said application (132) configured to facilitate a user associated with said user device (114) to scan said visual code, and further configured to re-direct the user to an encoded URL to view said product details, said application (132) configured to capture and transmit a browser ID and location data of said user device (114), said application (132) further configured to facilitate the user to provide at least one input corresponding to a set of pre-defined questions to ascertain whether or not said product is authentic; and
a server (110) configured to store said product details and cooperate with said first scanner (102) to facilitate assignment of said product details to said visual codes, said server (110) configured to cooperate with said user devices (114) to receive and store said browser ID and location data associated with scanning of visual codes on said products and said user inputs, said server (110) further configured to derive a plurality of scanning indices associated with each of said products based on said received browser ID and location data and identify whether or not said products are counterfeit, based on said scanning indices and said user inputs.

2. The system (100) as claimed in claim 1, wherein said first scanner (102) includes:
a video capturing device (104) configured to scan said images of the visual codes printed on said products; and
an assignment module (106) configured to cooperate with said server (110) to assign said product details to said visual codes.

3. The system (100) as claimed in claim 1, wherein said product details include batch number, manufacturing date, and expiry date.

4. The system as claimed in claim 1, wherein said application (132) includes:
a second scanner (116) configured to scan said visual code on said product and capture device ID and said location data of said user device (114), and further configured to re-direct said user to said encoded URL that opens in a browser where said user can view said product details, said second scanner (116) further configured to capture and transmit said browser ID and said location data to said server (110); and
a graphical interface (118) configured to facilitate the user to provide said inputs corresponding to said set of pre-defined questions to ascertain whether or not said product is authentic.

5. The system (100) as claimed in claim 1, wherein said server (110) includes:
a computation unit (134) configured to receive browser IDs and location data associated with scanning of the visual codes of each of said products, and further configured to derive said scanning indices based on said received browser IDs and location data;
a repository (108) configured to cooperate with said computation unit (134) and store:
a first lookup table having a list of product IDs associated with said products, browser ID and location data associated with scanning of said products, said scanning indices associated with each of said product IDs, and pre-determined thresholds corresponding to each of said scanning indices; and
a second lookup table having a list of said product IDs and said corresponding product details,
a verification module (120) configured to cooperate with said repository (108) and said user devices (114) to identify whether or not said products are counterfeit, based on said scanning indices and said inputs.

6. The system (100) as claimed in claim 5, wherein said scanning indices include:
number of said user devices that have scanned said product’s code (Nd);
count of number of location changes (NL);
location number or identification of said location (LN);
frequency of scans (F); and
time period between successive scans (T).

7. The system (100) as claimed in claim 6, wherein said pre-determined thresholds include:
maximum number of said user devices to scan said product on a retail shelf before buying said product and said code is killed/not available to scan anymore (X);
maximum number of said location changes (NL) allowed before said product is declared suspicious (Y);
maximum number of said location changes (NL) allowed before said product is declared as counterfeit (Z);
maximum scanning frequency (F) allowed before said product is declared as suspicious or counterfeit (F_{M}); and
maximum time period between successive scans (T) allowed before said product is declared as suspicious or counterfeit (T_{M}).

8. The system (100) as claimed in claim 7, wherein said verification module (120) includes:
a first comparator (122) configured to compare said Nd with said X, and further configured to generate a first fake signal if said Nd is less than or equal to said X, or else generate a positive signal;
a second comparator (124) configured to cooperate with said first comparator (122) to compare said NL with said Y upon receiving said positive signal, if NL is less than Y, said second comparator (124) further configured to compare current location of said user device (114) with its previous location stored in the repository (108) to:
generate a first genuine signal if the current location is same as the previous location; or
generate a second genuine signal and update the previous location to current location in the repository (108), if the current location is same as the previous location,
a third comparator (126) configured to compare N_{L} with Z, if N_{L} is found to be less than Y and determine if N_{L} is less than or equal to Z, said third comparator further configured to:
generate a suspicion signal if NL is found to be greater than Y but less than and equal to Z; or
generate a second fake signal if NL is found to be greater than Z,
a query generator (128) configured to receive said suspicion signal, and further configured to generate and transmit said set of pre-defined questions to said user device (114) to receive said inputs related to the product purchase;
an analyser (130) configured to analyse said inputs, and generate a third genuine signal if the product is found to be genuine based on said analysis, else generate a third fake signal; and
a notification generator (136) configured to cooperate with said first comparator (122), said second comparator (124), said third comparator (126), and said analyzer (128) to receive one of said first, second, and third fake signals and said first, second, and third genuine signals, said notification generator (136) further configured to generate and transmit:
a first message that the purchased product is genuine upon receiving one of said first, second and third genuine signals; and
a second message that the purchased product is counterfeit/fake upon receiving one of said first, second and third fake signals.

9. The system (100) as claimed in claim 1, wherein said first and second messages are received and displayed on said user device (114).

10. The system (100) as claimed in claim 7, wherein said server (110) includes a learning module (138) configured to periodically determine said the values of said pre-determined thresholds to accurately represent said product’s behavior by implementing machine learning techniques and update the values of said pre-determined thresholds in said repository (108).

11. A method (200) for detecting counterfeit products, said method (200) comprises the following steps:
scanning (202), by a first scanner (102), images of visual codes printed on products manufactured and packaged on a production line;
assigning (204), by said first scanner (102), product details to the visual code of each of said products;
facilitating (206), by an application (132) loaded in a user device (114), a user associated with said user device (114) to scan said visual code;
re-directing (208), by said application (132) loaded in a user device (114), said user to an encoded URL to view said product details;
capturing and transmitting (210), by said application (132) loaded in a user device (114), a browser ID and location data of said user device (114) to a server (110);
storing (212), by said server (110), said product details;
receiving and storing (214), by said server (110), said browser ID and location data associated with user devices (114) scanning said products and said user inputs;
deriving (216), by said server (110), scanning indices associated with each of said products based on said received browser ID and location data;
facilitating (218), by said application (132) loaded in a user device (114), said user to provide at least one input corresponding to a set of pre-defined questions to ascertain whether or not said product is authentic; and
identifying (220), by said server (110), whether or not said products are counterfeit, based on said scanning indices and said user inputs.
